(19) United States
(12) Patent Application Publication
(10) Pub. No.: US 2021/0159030 A1
(43) Pub. Date: May 27, 2021

(54) Universal circuit breaker interlock selection

(71) Applicant: Armando Dominguez, Pembroke Pines, FL (US)

(72) Inventor: Armando Dominguez, Pembroke Pines, FL (US)

(21) Appl. No.: 16/602,721

(22) Filed: Nov. 26, 2019

(51) Int. Cl. H01H 9/26; H01H 71/10

(52) U.S. Cl. CPC H01H 9/26; H01H 71/1045

(57) ABSTRACT

An adjustable distance lever circuit breaker interlock to prevent during selection that two different electric power sources feeds a circuit breaker busbar panel simultaneously. Adapted to be positioned between two vertically adjacent set of main circuit breaker feeders. One of the circuit breakers connected to the utilitarian power source and the other one connected to an auxiliary power source. Having a body and engagement similar to a circuit breaker interchangeable with different brands includes; General Electric, Siemens, Square D Home line, and others. Also works in the types twins and bricks main for panels. An alternative embodiment can be utilized in others types of branches including Square D type QO, and another alternative embodiment can be utilized for the types Din rails.

### CROSS-REFERENCE TO RELATIVE APPLICATIONS

Design U.S. Pat. No. D834,534 S. Nov. 27, 2018

### STATEMENT REGARDING FEDERALLY SPONSORED RESEARCH

None

### BACKGROUND

### Prior Art

The following is a tabulation of some prior art that presently appears relevant:
U.S. Pat. No. 3,492,448 to Lawrence Phillips
U.S. Pat. No. 6,028,272 to Akers
U.S. Pat. No. 5,001,315 to Runyan
U.S. 2004/0032702 to Gibson
U.S. Pat. No. 4,665,284 to Guinan

### Field of the Invention

The invention relates to circuit breaker interlocking devices mounted “side by side”, which control two different power sources feeding the same circuit breaker loading panel, for preventing the simultaneous energization of its bus bar. More particularly for aftermarket interlock which can be utilized for variety of brands and configurations.

### Background of the Invention

The invention relates to interlocking devices which are designed to protect auxiliary power means connected to a circuit breaker panel performing cooperatively with utilitarian power source, to prevent the actuation of one circuit breaker when an adjacent main circuit breaker is actuated or vise verse to prevent damages to the generator or auxiliary power means and to the utilitarian employee corporation working in the assigned transformer lines.

My invention is suitable for using in multiple poles circuit breakers, including the types residential, bolt-on, Square D type “QO”, Federal Pacific, Simsco, etc.

Many interlocking devices have being utilized to prevent from feed the same panel simultaneously, but each brand manufacturer has have created its own configuration which only feeds successfully in its circuit breaker handle distance-configuration.

Circuit breaker manufacturer has made changes to the circuit breaker handle distance-configuration through time, and as result the electrical contractors have difficulties choosing the right interlock for the same brand of a circuit breaker board in question.

No manufacturer of circuit breaker interlocks has created an economical and versatile interlock which can be successfully utilized to accommodates with the needs of the market, allowing the electrical contractors to get one interlock which can be utilized in almost all of the popular brands.

### SUMMARY OF THE INVENTION

I presently prefer to illustrate my invention as a exemplary embodiment which comprises a cast body like one full size single pole circuit breaker without the internal electrical components and the toggle-type handle switching section, which are replaced for an adjustable distance interlock lever mechanism having a centralized housing bushing in which an eccentric bushing secure the lever pivotable mounts by a fastener means. It mounts in the circuit breaker panel like a common full size single circuit breaker between two main circuit breakers, but commercial and industrial circuit breakers including the type Din rails, bolt-on, Federal Pacific, Square D type QO, etc can receive the benefits of my invention even when are not fully disclosure in details in this application.

Its main function is for preventing the actuation of an adjacent laterally spaced pair of toggle-type circuit breaker mains getting the same “on” position at once, to avoid connect two power sources in a panel which might produce damages to the auxiliary power source, or its overload protection means, also reversing a transformer terminal's energy, which might provoke injuries or fatality to an utilitarian worker.

Further, I'll disclose in details one of the multiple ways of its build and use.

My preferred embodiment provides an adjustable toggle handle interlocking between two main circuit breakers, which works in most of all the same type/size of circuit breakers panels, designed to be installed “side by side”. I presently prefer to disclose my invention as an adjustable center panel distance to the handle lever which is pivotally mounted in a cast like circuit breaker, made of a type dielectric composite, resin or plastic, which have at least one threaded hole in its front surface to secure a bushing shaft screw. The bushing can rotate 360 degrees to secure the lever wings in the appropriate distance to the main circuit breakers toggle handles, but also can be flip to reach an additional range of the distance, and moved to the adjacent bushing screw housing.

The lever interlocker member has two wings which presently are illustrated symmetrically extended from the center to both opposite ends, a centralized bearing housing, an eccentric shouldered bearing mounted into the bearing housing, secures by means of the shaft screw to the front cast surface hole, allowing the lever to freely pivot in the shouldered bushing.

It has at the rear left side a pair of columns which works as a busbar terminal female slot coupling, which is designed to firmly engage in almost all of the circuit breakers, including General Electric twin terminals, having a male plunger terminal, which section measures approximately 0.800 wide×0.060 high, But for the Square D type “QO” corporation which have the same engagement and dimensions.

Once my interlock is mounted between the two main circuit breakers the eccentric bushing is rotated to get the correct one interlocking position with one breaker in “on” position and the other one in “off” position, and the shaft screw secure the bushing against the cast, at this point none of the main circuit breakers can get to the “on” position at the same time.

To complete the installation, a notice like “do not remove” should be visible set in the interlocker.

A second alternative embodiment includes a body shape with the brand Square D type QO circuit breaker configuration having the same above mechanism to allow the same circuit breaker interlock performance.

A third alternative embodiment includes a body shape adapted to work with the multiple types “DIN” rail circuit breakers.

A fourth alternative embodiment includes a body shape having the same configuration of the bolt-on circuit breakers.

An additional embodiment includes a busbar bolt-on adapter which convert the bolt-on busbar into a residential terminal to allows the use of various types of bolt-on branches having different screw distances.

Another additional for bolt-on type circuit breakers includes a single case body having in the bar coupling connection a protuberance in which a slotted section has two screws housing designed to receive a screw in each one to secured a branch GE or Siemens circuit breaker mains.

Any adjustable distance mechanism installed in said cast, which allows to adjust the lever interlocker member to a substantial safety distance from the first and second main circuit breaker toggle handle switch can be utilized to successfully build and utilize the invention.

Further I'll disclose in detail one of the multiple ways to built it.

### BRIEF DESCRIPTION OF THE DRAWINGS

FIG. 1 is a perspective view of an exemplary embodiment of the present interlocker constructed in accordance with the present invention showing a partial exploded view of the front section, and a partial broken view of the circuit breaker busbar assembly, which illustrates the engagement means and shape for some brands, including General Electric, Siemens, Eton, Square D home line, Westinghouse etc. A view reference box have been incorporated to the figure. a phantom line is use to indicate a behind section of a surface.

FIG. 2 is a second perspective view illustrating at the left side a partial broken view, heavy phantom lines are utilized to show the cutting section plane and direction. Heavy center lines are utilized to point out to a group of objects which form a combined shape. A twin General Electric brand circuit breaker busbar has been utilized as reference.

FIG. 2A illustrates a partial cutting view coming from the FIG. 2, the arrows 26 indicates the force direction of the interlock busbar columns.

FIG. 3 show a fourth perspective view illustrating in a heavy center line a group of objects which form a combined shape designated to engage in the lateral panel busbar assembly.

FIG. 4 illustrates a fifth perspective view showing a partial broken view of the busbar assembly.

FIG. 5 show a sixth perspective view of the exemplary embodiment in its environment, one main circuit breaker appear as a type brick, the other as a regular main circuit breaker configuration.

FIG. 6 shows a seventh perspective view of the exemplary embodiment in its working position.

FIG. 7 illustrates an eighth exploded perspective view of an alternative embodiment of the present invention suitable for the Square D type “QO” circuit breakers, not showing the main circuit breakers and busbar assembly.

FIG. 8 shows the exemplary embodiment installed between two type brick main circuit breakers.

FIG. 9 illustrates a plan view of the interlock member in working position.

FIG. 9A shows a plan view of interlock member flipped.

FIG. 10 illustrates a perspective view of an additional embodiment of the present invention to adapt the exemplary embodiment to several types bolt-on circuit breaker.

FIG. 11 shows the adapter in a perspective view.

FIG. 12 shows a partial cutting perspective view of the present invention in an installed cycle, the arrow indicate the movement's direction.

FIG. 13 illustrates a partial cutting perspective view of the additional embodiment in working position.

FIG. 14 shows a partial cutting perspective view of the exemplary embodiment installed in the bolt-on adapter.

FIG. 15 illustrates another additional embodiment of the present invention having two holes to be utilized in various brands including General Electric and Siemens.

FIG. 16 shows a perspective view of another alternative embodiment of the present invention in which a bolt-on single cast can be utilized to work in several brands of circuit breaker mains, including general electric and Siemens.

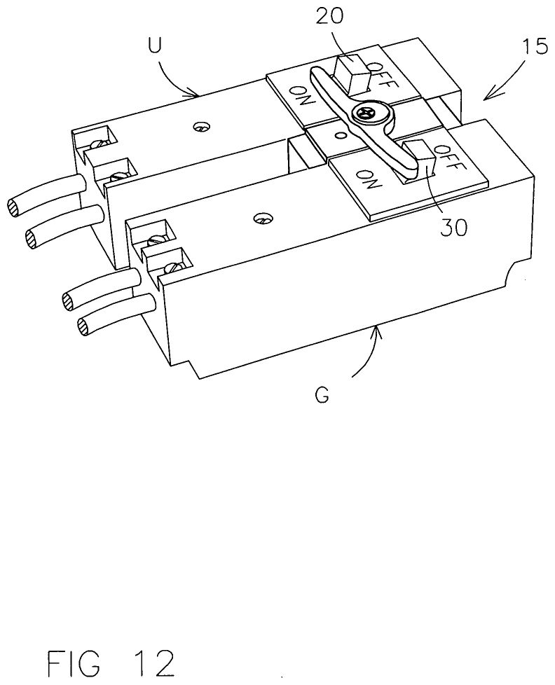

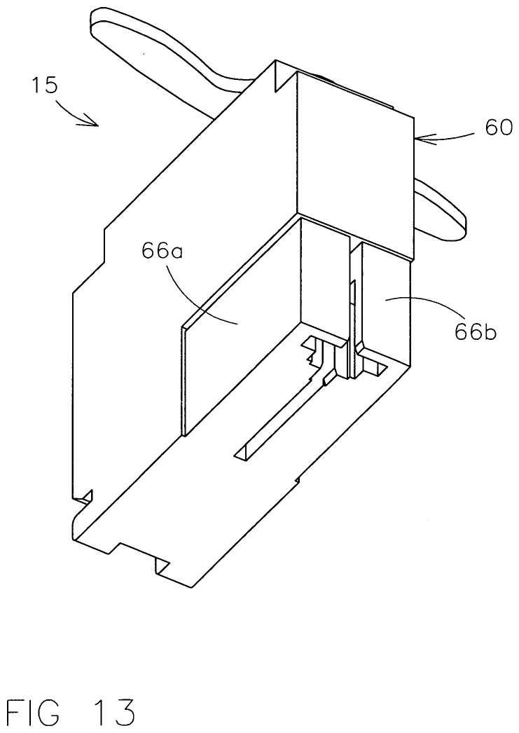

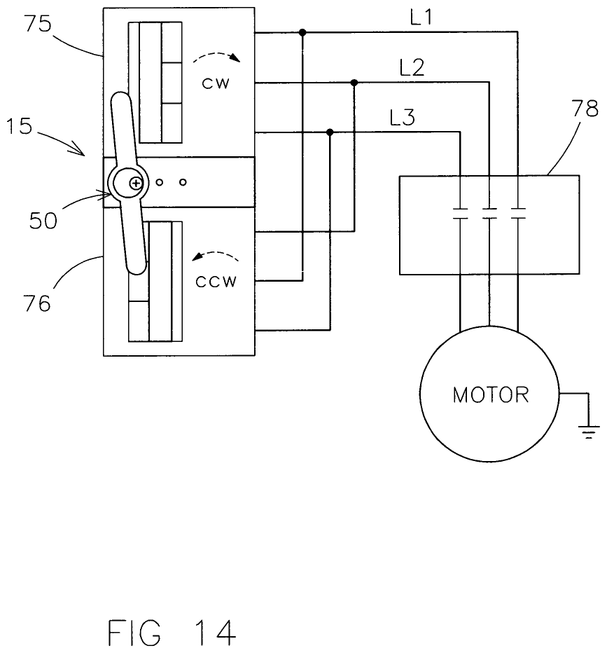

FIGS. 12, 13, 14 and 16 does not show the interlocker member, eccentric bushing and bushing holder screw.

| | |
|---|---|
| 10 exemplary embodiment | 20 main cast body |
| 21a upper cast wall | 21b lower cast wall |
| 22a right upper body recessed section | 22b left lower body recessed section |
| 23 flat front surface | 24 panel assembly coupling |
| 25 busbar female slot | 26 arrow indication press direction |
| 27a upper busbar gripper | 27b lower busbar gripper |
| 28a body lower projection | 30a upper busbar gripper column |
| 30b lower busbar gripper column | 31b twin plug housing |
| 33a upper busbar column slot | 33b lower busbar column slot |
| 34a rear busbar limiter surface | 35b twin general electric coupler |
| 34b rear busbar limiter surface | |
| 40 lever assembly | 44 upper wing surface |
| 45 lower wing surface | 48 bushing shoulder |
| 49 bushing housing | 50 lever |
| 51 routable eccentric lever bushing | 52 bushing radial surface |
| 53 lower lever surface | 55 threaded screw section |
| 56 lever thrust upper bushing surface | 58 threaded screw shaft |
| 60 busbar assembly | 63a upper arcade barrier |
| 63b lower arcade barrier | 64 male panel body |
| 66 hot busbar male plunger | 67a upper “L” shape |
| 67b lower “L” shape support busbar surface | 69a upper column surface |
| 69b lower column busbar | 70 auxiliary circuit breaker panel feeder |
| 71 main circuit break type brick | 72 auxiliary circuit breaker feeder |
| 73 auxiliary circuit breaker handle | 74 brick main circuit breaker handle |
| 75 auxiliary circuit breaker handle | 80 adjustable member |
| 82 slot | 90 GE-Siemens bolt-on adapter |
| 91 bolt head upper slot | 91a bolt-on busbar surface |
| 92 bolt head arch housing | |
| 93G General Electric brand bolt housing | 93S Siemens brand bolt housing |
| 94 bolt-on GE/Siemens slot | 95a top adapter edge |
| 95b bottom adapter edge | 96a left top adapter edge |
| 96b left bottom adapter edge | 97 adapter wedge section |
| 98a front bolt-on adapter surface | 98b cast body stop adapter surface |
| 99a cast adapter housing | 100 bolt-on single cast body |
| 101 GE/Siemens common slotted section | |

### DESCRIPTION OF THE EXEMPLARY EMBODIMENT

### Construction of the Exemplary Embodiment

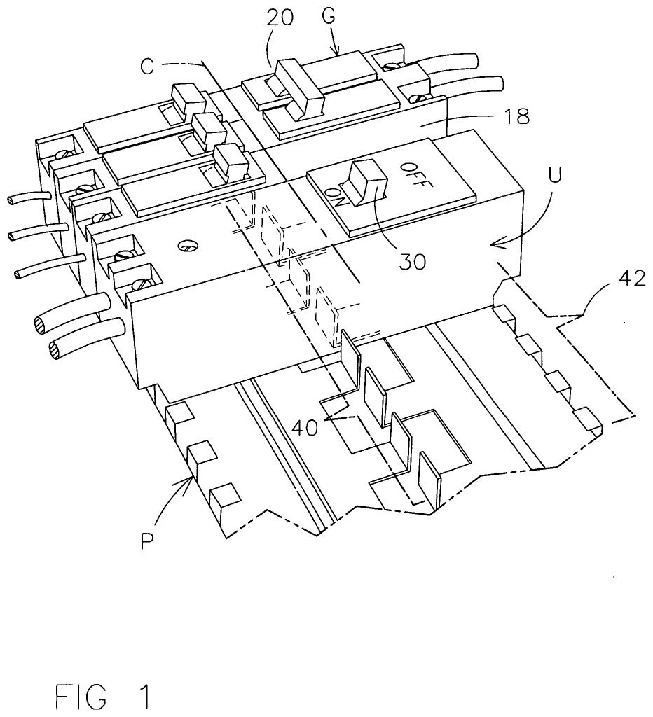

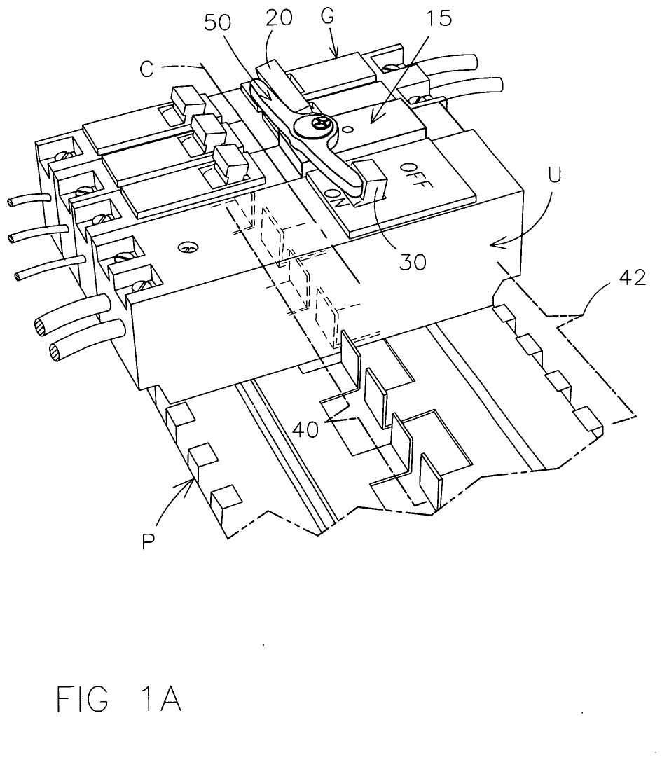

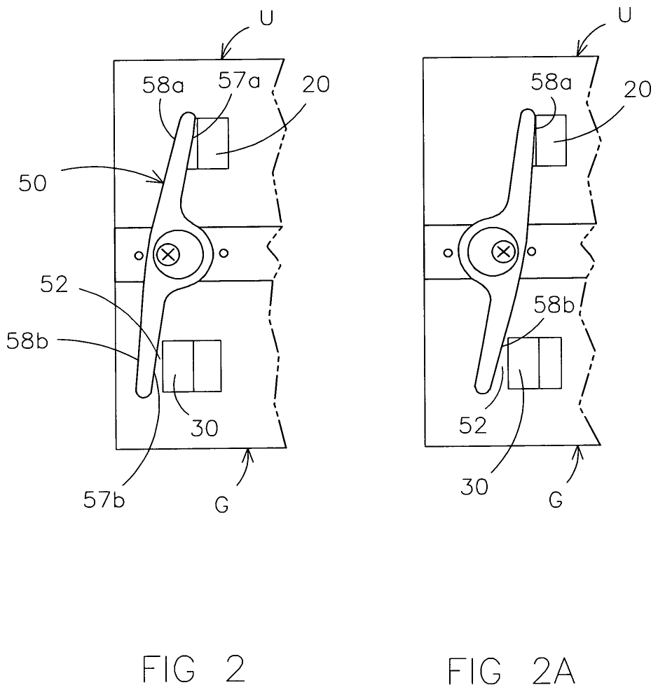

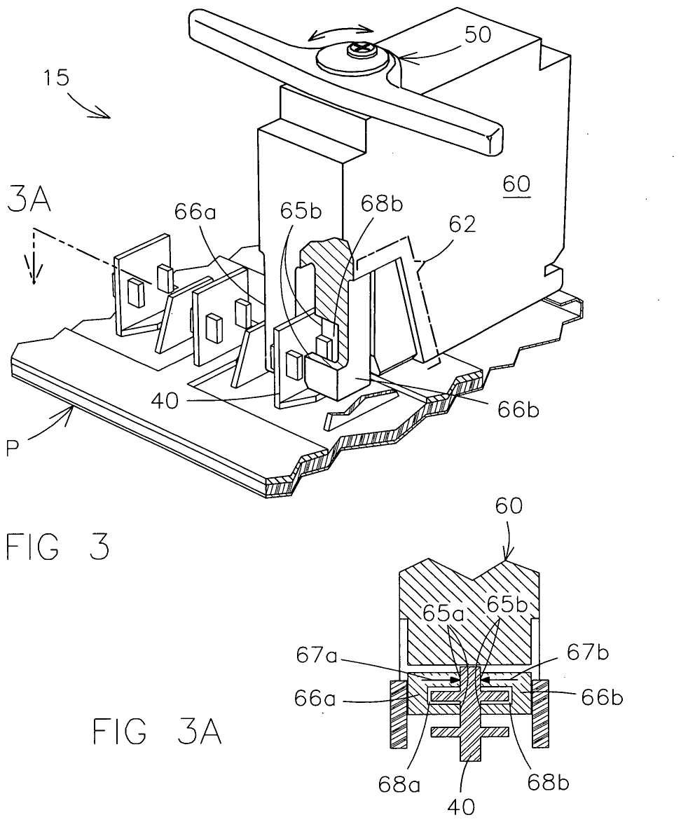

FIG. 1 illustrate the exemplary embodiment 10 which illustrates three main groups of parts.

The first group is a cast body 20 preferably made of an dielectric composite, resin or plastic, having a high level of rigidness with a shape, and engagement like a circuit breaker of the brands; General Electric, Siemens, Cutler hammer, Westinghouse, Eaton or other with a similar shape.

The second group is a lever assembly 40 which includes a lever 50, an eccentric shouldered bushing 51 and a threaded screw shaft 58 preferably having a tampered head.

The third group is a circuit breaker assembly 60 which appear in a partial cutting section view and does not form part of the invention.

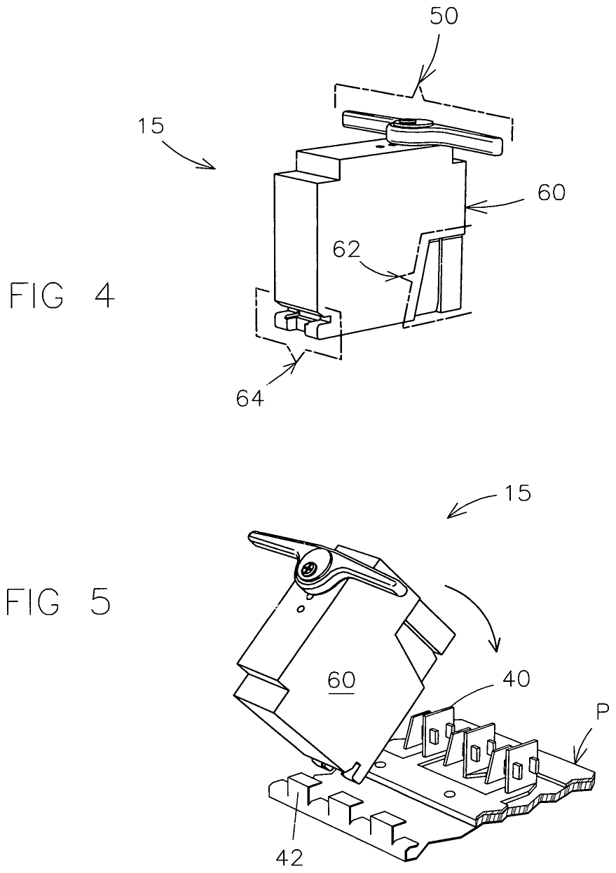

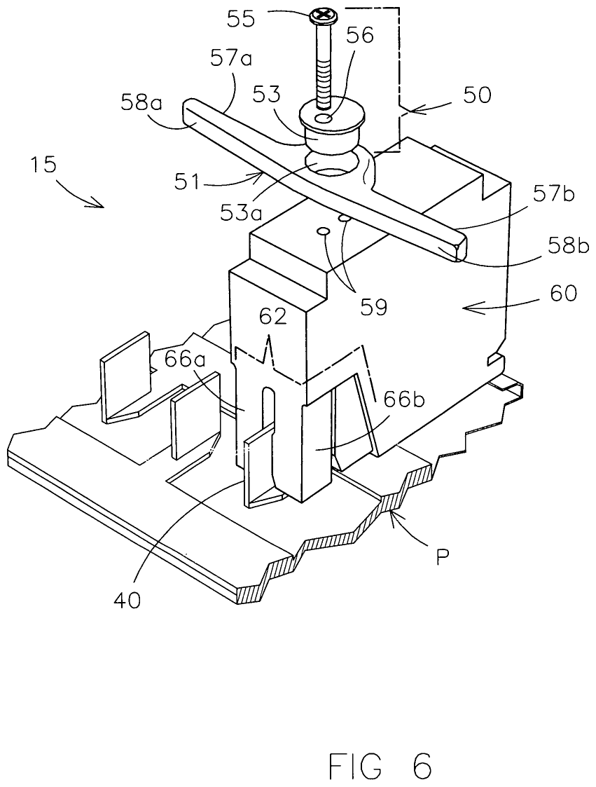

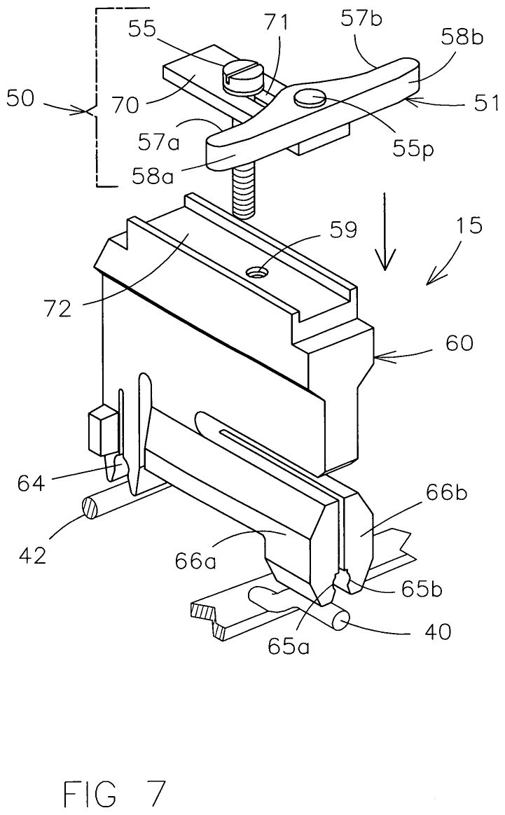

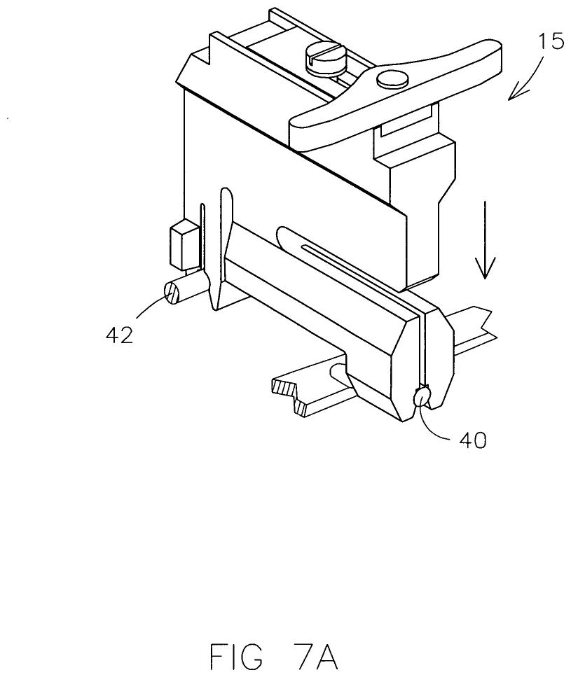

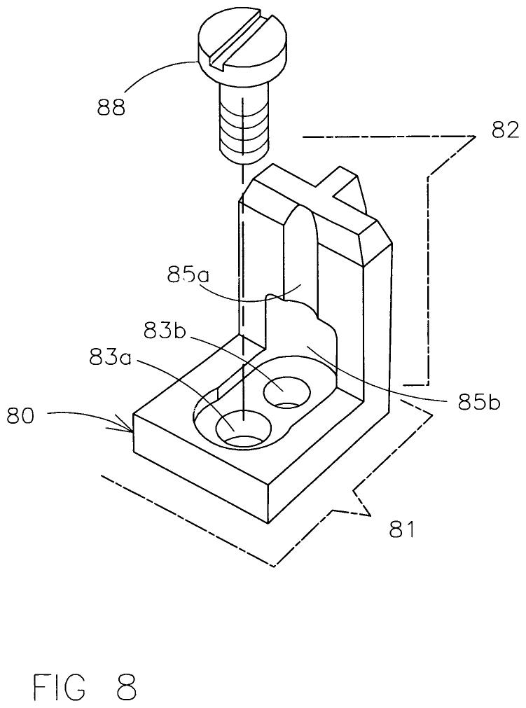

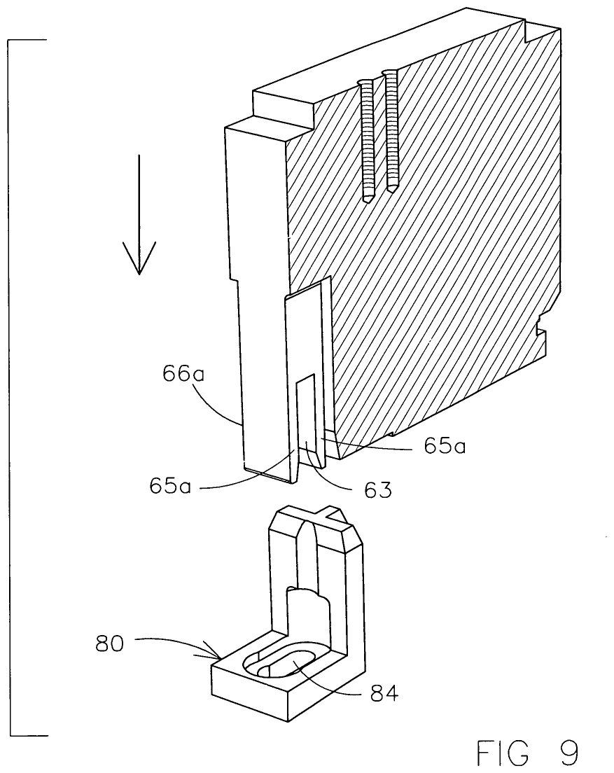

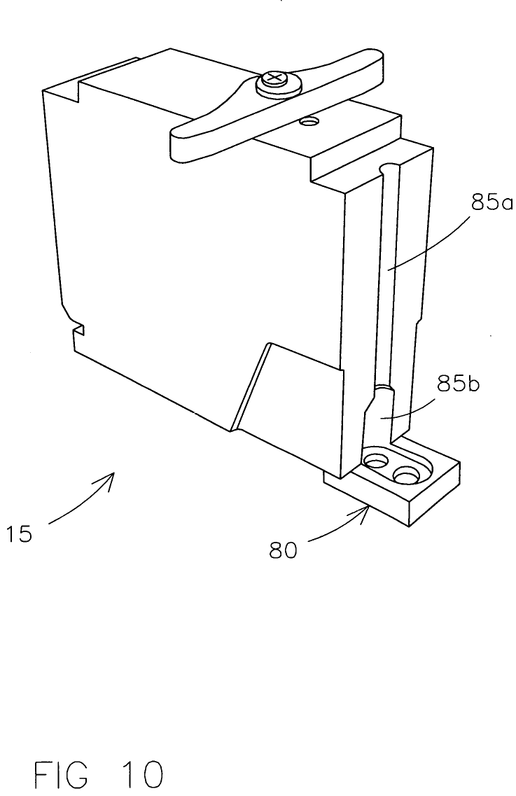

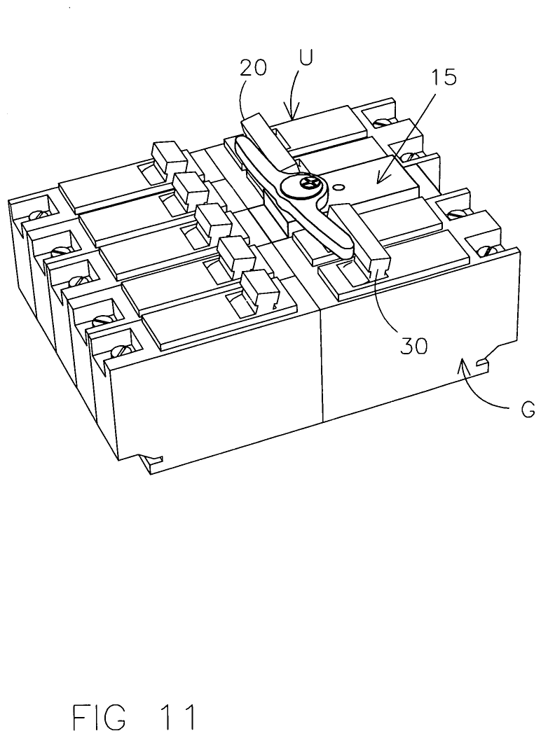

FIG. 1: My exemplary embodiment 10 comprise a body 20 which has an appearance like one full size single pole circuit breaker, includes an adjustable distance interlock lever 50 having a centralized housing bushing 49 in which an eccentric bushing 51 secures the lever 50 allowing a pivot, the bushing is firm mount over the surface 23 by a fastener means 58 threaded in an fastener housing 25a or 25b depending of the distance needed from the center panel. FIG. 4: It mounts in the circuit breaker panel like a common full size single circuit breaker between two main circuit breakers 70, 71 and 72 as illustrated in the FIGS. 5, 6, 8, 9 and 9A, but commercial and industrial circuit breakers including the type “DIN” rails, bolt-on, Federal Pacific, Square D type “QO”, etc can receive the benefits of my invention, even when are not fully disclosed in detail.

The cast 20 mounts between the two main circuit breakers 70 and 71 along with the eccentric bushing 51 which is rotated to reach the safety distance from the wings surface 44a and 45a or 44b and 45b (FIGS. 9 and 9A), then the screw 50 secures the bushing 51. Its main function is to be mounted and set in a position for preventing the actuation of an adjacent laterally spaced pair of toggle-type circuit breakers mains getting the same “on” position at once, to avoid connecting two power sources in a panel which might produce damages to the auxiliary power sources, or its overload protection means, also reversing a transformer terminals energy, which might provoke injures or fatality to an utilitarian worker.

My preferred embodiment provides an adjustable circuit breaker toggle handle interlock switch, which works in most of all the same type-size of circuit breakers panels, designed to be installed “side by side”. I presently preferred disclosing my invention as an adjustable distance from the center panel to the handle lever, which is pivotally mounted in a cast like circuit breaker, preferably made of a type dielectric composite, resin or plastic, which has at least one threaded hole in its front surface to secure a bushing shaft screw. The bushing can be rotated to set the lever wings in the appropriate distance to the mains circuit breakers toggle handles, but also can be flipped to reach an additional range of the distance also moved to the adjacent bushing screw housing, which presently illustrates only a pair of them.

The lever has two wings which symmetrically extend from the center to both opposite ends, a centralized bearing housing, an eccentric shouldered bearing mounted into the bearing housing, secured by means of the shaft screw to the front cast surface hole, allowing the lever to freely pivot in the shouldered bushing.

It has at the rear left side a pair of columns which work as a busbar terminal female slot coupling, which is designed to firmly engage in almost all of the circuit breaker of the above said circuit breakers category, including General Electric twins terminal, and having a male plunger terminal which section measuring approximately 0.800 width×0.060 high, or for other dimensions. But for the breakers of the Square D corporation and Federal Pacific I designed a cast which have the same engagement and dimensions.

### How to Use the Invention:

Once my interlock is mounted between the two main circuit breakers the eccentric bushing is rotated to get the correct one interlocking position with one breaker in “on” position and the other one in “off” position, and the shaft screw secure the bushing against the cast front surface, at this point none of the circuit breaker mains can get the “on” position at the same time.

A second alternative embodiment includes a body shape with the brand Square D type QO circuit breaker configuration having the same above mechanism to allow the same circuit breaker interlock performance.

A third alternative embodiment includes a body shape adapted to work with the multiple types “DIN” rail circuit breakers.

A fourth alternative embodiment includes a body shape having the same configuration of the bolt-on circuit breakers.

An additional embodiment includes an busbar bolt-on adapter which converts the bolt-on busbar into a residential terminal to allows to use various types of bolt-on brands having different screw distances.

Another additional for bolt-on type circuit breakers includes a single cast body having in the bar coupling connection a protuberance in which a slotted section has two screw housings designed to receive a screw in each one to secure a brand GE or Siemens circuit breaker mains.

What is claimed is:

1. An electric distribution load panel board with a first main circuit breaker and a second main circuit breaker, installed laterally spaced, leaving one full size single circuit breaker space between both, first main breaker connected to an electric power utility service, the second one connected to an auxiliary power source, having each main a toggle handle switching element which on dependence of the manufacturer can have a varied distances from the center panel to the toggle handle, which might appears in different shapes, for manually closes its electric contacts by pulling the toggle handle from the panel edge to the center panel direction, or for openings the contacts by pulling the toggle handle in the opposite direction, energizing the panel busbar when are closed, a new universal interlock having a like circuit breaker shape, engagement, dimensions and dielectric properties without the toggle handle switching assembly and internal components, to engage in said leaved space like a single full size circuit breaker for interrupting the complete closing contact cycle of the any oi said main circuit breakers toggle handles when the contacts of the other one are closed, comprises;
a horizontally symmetric body, having an appearance of a single circuit breaker, includes a front, rear, left, right, top and bottom section which has a vertical slot that extends from the bottom to the middle of the body, a recessed section at the bottom left upper and lower section, which extends from the bottom and left walls to the lever assembly, an adjustable distance lever means adjust the wings-toggle handle switching distance to a point that allows to pivot the lever, which includes a lever having a shape like a two thin wings, which is set at the front of the “on” position of the toggle switches of the each main circuit breaker,

2. The new interlock claimed in claim 1 wherein said having a interlocker lever mounted in a distance adjustable by sliding its plate member which can be secured to the cast body by a fastener means, having in its bottom left and right side the same engagement which has the type circuit breaker QO Square D brand.
Any adjustable distance mechanism installed in said cast top surface, which allows to adjust the lever interlocker member to a substantial safety distance from the first and second main circuit breaker toggle handle switching can be utilized for successfully builds and utilizes the invention.
